(19) United States
(12) Patent Application Publication
(10) Pub. No.: US 2007/0186126 A1
(43) Pub. Date: Aug. 9, 2007

(54) Fault tolerance in a distributed processing network

(75) Inventors: Grant L. Smith, Tampa, FL (US); Jason C. Noah, Redington Shores, FL (US); Clifford E. Kimmery, Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/348,277

(22) Filed: Feb. 6, 2006

(51) Int. Cl. G06F 11/00

(52) U.S. Cl. 714/4

(57) ABSTRACT

A distributed processing network is disclosed. The network includes at least one network switch, coupled to one or more end nodes, and adapted to simultaneously receive and route a plurality of data packets between the one or more end nodes. Within the network, the one or more end nodes are interconnected by one or more communication links adapted to provide a predetermined level of fault tolerant error detection and recovery.

### RELATED APPLICATIONS

The present application is related to commonly assigned and co-pending U.S. patent application Ser. No. ______ (Attorney Docket No. H0011503-5802) entitled “FAULT TOLERANT COMPUTING SYSTEM”, filed on even date herewith, which is incorporated herein by reference, and also referred to here as the '11503 Application (U.S. Ser. No. ______)

### GOVERNMENT INTEREST STATEMENT

The U.S. Government may have certain rights in the present invention as provided for by the terms of a restricted government contract.

### BACKGROUND

Present and future high-reliability (i.e., space) missions require significant increases in on-board signal processing. Presently, generated data is not transmitted via downlink channels in a reasonable time. As users of the generated data demand faster access, increasingly more data reduction or feature extraction processing is performed directly on the high-reliability vehicle (e.g., spacecraft) involved. Increasing processing power on the high-reliability vehicle provides an opportunity to narrow the bandwidth for the generated data and/or increase the number of independent user channels.

In signal processing applications, traditional instruction-based processor approaches are unable to compete with million-gate, field-programmable gate array (FPGA)-based processing solutions. Distributed computing systems with multiple FPGA-based processors are required to meet the computing needs for Space Based Radar (SBR), next-generation adaptive beam forming, and adaptive modulation space-based communication programs. As the name implies, a distributed system that is FPGA-based is easily reconfigured to meet new requirements. FPGA-based reconfigurable processing architectures are also reusable and able to support multiple space programs with relatively simple changes to their unique data interfaces.

Before operating, FPGAs (and similar programmable logic devices) must have their configuration memory loaded with an image that connects their internal functional logical blocks. Traditionally, this is accomplished using a local serial electrically-erasable programmable read-only memory (EEPROM) device or a local microprocessor reading a file from local memory to load the image into the FPGA. Present and future high-reliability signal processing assemblies (and other networked systems) must be capable of remote and continuous reconfiguration for not only one FPGA, but multiple FPGAs with identical images. An example is three or more FPGAs, operating with identical images and a common clock, that incorporate a triple modular redundant (TMR) architecture to improve radiation tolerance. However, fault- and radiation-tolerant reconfigurable computing assemblies that only contain FPGAs and no local microcontroller require a different approach to configuration management.

State-of-the-art high-reliability signal processing assembly interconnects are currently based upon multi-drop configurations such as Module Bus, PCI and VME. These multi-drop configurations distribute available bandwidth over each module in the system, but also produce points of contention among participant nodes. These points of contention typically result in unwanted system-level communication constraints. As described in detail below, the present invention provides fault tolerance in an inter-processor communications network that resolves the above-described problems with increased processing power and bandwidth availability, along with resolving other related problems.

### SUMMARY

Embodiments of the present invention address problems with providing fault tolerance in an inter-processor communications network and will be understood by reading and studying the following specification. Particularly, in one embodiment, a distributed processing network is provided. The network includes at least one network switch, coupled to one or more end nodes, and adapted to simultaneously receive and route a plurality of data packets between the one or more end nodes. Within the network, the one or more end nodes are interconnected by one or more communication links adapted to provide a predetermined level of fault tolerant error detection and recovery.

### DRAWINGS

FIG. 1 is a block diagram of an embodiment of a distributed processing network according to the teachings of the present invention; and

FIG. 2 is a flow diagram illustrating an embodiment of a method for transferring one or more data packets over a distributed network according to the teachings of the present invention.

Like reference numbers and designations in the various drawings indicate like elements.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical, and electrical changes may be made without departing from the spirit and scope of the present invention. The following detailed description is, therefore, not to be taken in a limiting sense.

Embodiments of the present invention address problems with providing fault tolerance in an inter-processor communications network and will be understood by reading and studying the following specification. Particularly, in one embodiment, a distributed processing network is provided. The network includes at least one network switch, coupled to one or more end nodes, and adapted to simultaneously receive and route a plurality of data packets between the one or more end nodes. Within the network, the one or more end nodes are interconnected by one or more communication links adapted to provide a predetermined level of fault tolerant error detection and recovery.

Although the examples of embodiments in this specification are described in terms of distributed network applications, embodiments of the present invention are not limited to distributed network applications. Embodiments of the present invention are applicable to any computing application that requires concurrent processing in order to maintain operation of a high-reliability, distributed processing application. Alternate embodiments of the present invention utilize an inter-processor communications network interface that is sufficiently tolerant of one or more fault conditions while maintaining sufficient levels of processing power and available bandwidth. The inter-processor communications network is capable of controlling concurrent configurations of one or more processing elements on one or more reconfigurable computing platforms.

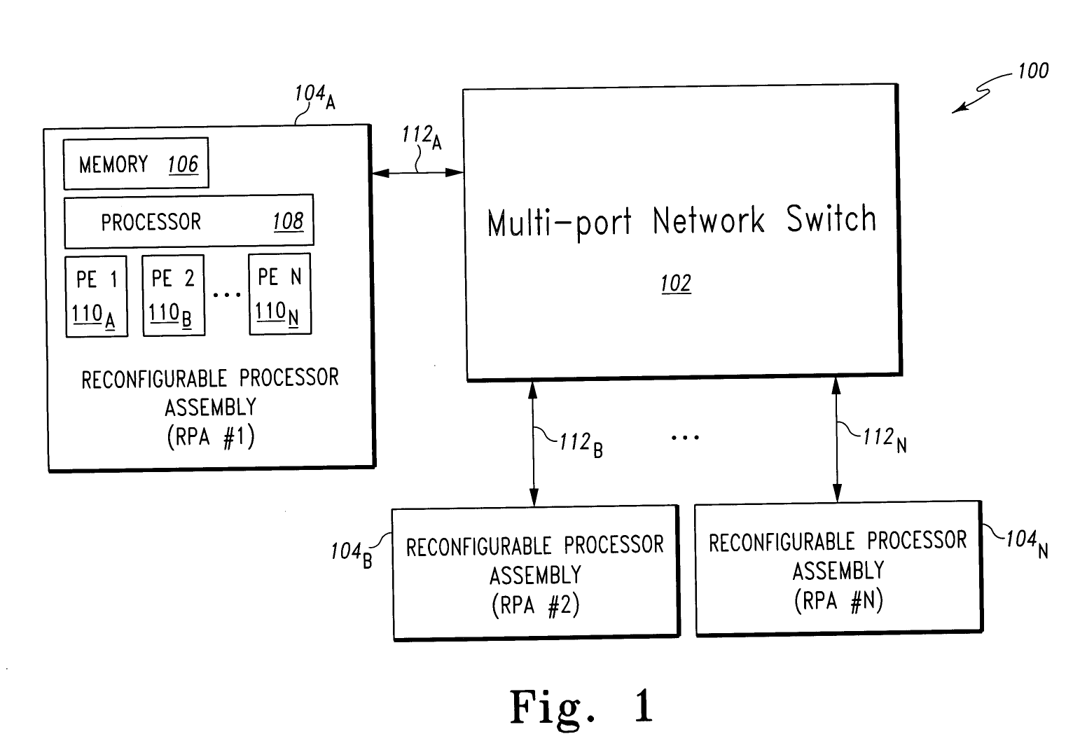

FIG. 1 is a block diagram of an embodiment of a distributed processing network, indicated generally at 100, according to the teachings of the present invention. Network 100 includes multi-port network switch 102 and reconfigurable processor assembly (RPA) 104_{A} to 104_{N}. Each of RPA 104_{A} to 104_{N} is considered a distributed processing node, and is coupled for data communications via each of distributed processing network interface connections 112_{A} to 112_{N}, respectively. It is noted that for simplicity in description, a total of three reconfigurable processor assemblies 104_{A} to 104_{N} and distributed processing network interface connections 112_{A} to 112_{N} are shown in FIG. 1. However, it is understood that network 100 supports any appropriate number of reconfigurable processor assemblies 104 and distributed processing network interface connections 112 (e.g., one or more reconfigurable processor assemblies and one or more distributed processing network interface connections) in a single network 100.

RPA 104_{A} further includes RPA memory device 106, RPA processor 108, and three or more RPA processing elements 110_{A} to 110_{N}, each of which is discussed in turn below. It is noted and understood that for simplicity in description, the elements of RPA 104_{A} are also included in each of RPA 104_{A} to 104_{N} RPA memory device 106 and the three (or more) RPA processing elements 110_{A} to 110_{N} are coupled to RPA processor 108 as described in the '11503 application. In this example embodiment, RPA memory 106 is a double-data rate synchronous dynamic read-only memory (DDR SDRAM) or the like. RPA processor 108 is any programmable logic device (e.g., an application-specific integrated circuit or ASIC), with at least a configuration manager logic block and an interface to provide at least one output to the distributed processing application of network 100. Each of RPA processing elements 110_{A} to 110_{N} is a programmable logic device such as an FPGA, a complex programmable logic device (CPLD), a field-programmable object array (FPOA), or the like. It is noted that for simplicity in description, a total of three RPA processing elements 110_{A} to 110_{N} are shown in FIG. 1. However, it is understood that each of reconfigurable processor assemblies 104_{A} to 104_{N} supports any appropriate number of RPA processing elements 110 (e.g., one or more RPA processing elements) in a single reconfigurable processor assembly 104.

In this example embodiment, multi-port network switch 102 and distributed processing network interface connections 112_{A} to 112_{N} form a RAPIDIO® (RapidIO) inter-processor communications network. Distributed processing network interface connections 112_{A} to 112_{N} support bandwidths of up to 10 gigabits per second (GB/s) for each active link. Each of distributed processing network interface connections 112_{A} to 112_{N} is implemented with a high-speed parallel or serial interface for any inter-processor communications network that embodies packet-switched technology.

In operation, each of RPA 104_{A} to 104_{N} functions as described in the '11503 application. Distributed processing network interface 112_{A} to 112_{N} provides each of RPA 104_{A} to 104_{N} with a point-to-point link to multi-port network switch 102. Multi-port network switch 102 simultaneously receives and routes a plurality of data packets to an appropriate destination (i.e., one of RPA 104_{A} to 104_{N}.) The non-blocking nature of network 100 allows concurrent routing of the plurality of data packets. For example, input data is routed to and stored in a globally available memory of one of RPA 104_{A} to 104_{N} at the same time as RPA processor 108 in RPA 104_{A} is sending configuration information to RPA 104_{B}. Distributed processing network interface 112_{A} to 112_{N} reduces contention and delivers more bandwidth to the application by allowing multiple full-bandwidth point-to-point links to be simultaneously established between each of RPA 104_{A} to 104_{N} in network 100.

Notably, the inter-processor communications network protocol implemented through distributed processing network interface 106_{A} to 106_{N} contains extensive fault tolerant error-detection and recovery mechanisms. The extensive fault tolerant error-detection and recovery mechanisms combine retry protocols, cyclic redundancy codes (CRC), and single or multiple error detection to handle a substantial amount of network errors. Further, network 100 maintains a sufficient fault tolerance level without additional intervention from a system controller as described in the '11503 application. The error handling and recovery capability of network 100 controls operation for any distributed processing application that requires a highly reliable interconnect.

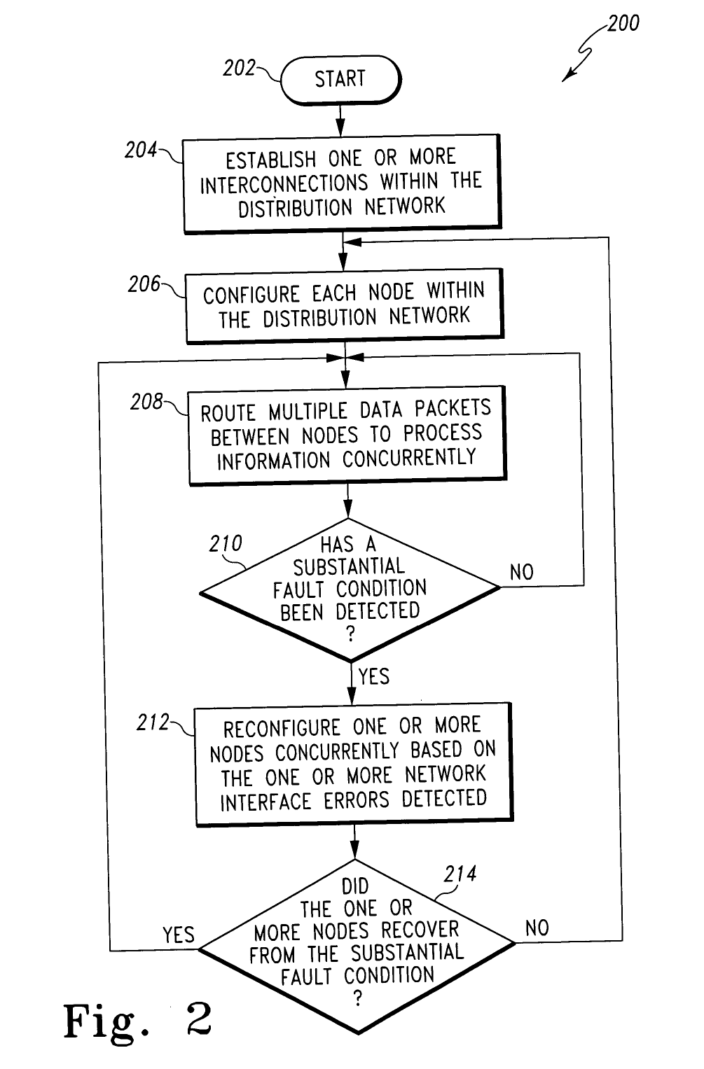

FIG. 2 is a flow diagram illustrating a method 200 for transferring one or more data packets over a distributed network, in accordance with a preferred embodiment of the present invention. The method of FIG. 2 starts at step 202. In an example embodiment, after one or more interconnections are established within network 100 of FIG. 1 at step 204, method 200 begins the transfer of one or more data packets over network 100. A primary function of method 200 is to provide fault tolerance for network 100 with sufficient error handling and recovery capability.

At step 206, the method configures each of the one or more end nodes within the distributed network. In this example embodiment, the one or more end nodes are one or more of RPAs 104_{A} to 104_{N} as described above with respect to FIG. 1 and are configured as further described in the '11503 application. Once the one or more of RPAs 104_{A} to 104_{N} are configured and communications are established within network 100, step 208 routes multiple data packets between the one or more of RPAs 104_{A} to 104_{N} simultaneously, which allows information to be processed concurrently. As information is processed concurrently, step 210 determines whether a substantial fault condition has been detected. In this example embodiment, the substantial fault condition is a sufficient series of single event upsets, single event transients, single event functional interrupts, or the like, that affect the validity of the information being processed concurrently, as further described in the '11503 application. If no substantial fault conditions are detected, the method returns to step 208. If at least one substantial fault condition is detected, method 200 proceeds to step 212. Step 212 provides a recovery mechanism from the at least one substantial fault condition without additional intervention from a system controller, as described earlier with respect to FIG. 1. In this example embodiment, the recovery mechanism of step 212 involves one or more concurrent reconfigurations of one or more of RPAs 104_{A} to 104_{N} that sustain the at least one substantial fault condition, as further described in the '11503 application. Once the recovery is complete, the method at step 214 determines whether the one or more of RPAs 104_{A} to 104_{N} recovered from the at least one substantial fault condition. If the recovery was successful, the method returns to step 208. If the recovery was not successful, the method returns to step 206.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A distributed processing network, comprising:
one or more end nodes interconnected by one or more communication links, the one or more communication links adapted to provide a predetermined level of fault tolerant error detection and recovery; and
at least one network switch, coupled to the one or more end nodes, the at least one network switch adapted to simultaneously receive and route a plurality of data packets between the one or more end nodes.

2. The network of claim 1, wherein the one or more end nodes are interconnected by a RapidIO communications network interface.

3. The network of claim 1, wherein the one or more end nodes are interconnected by an inter-processor communications network interface.

4. The network of claim 1, wherein the predetermined level of fault tolerant error detection and recovery comprises a reconfiguration of one or more processing elements in the one or more end nodes that sustain at least one substantial single event fault condition.

5. A distributed processing node, comprising:
at least one distributed network connection responsive to at least one network switch;
a fault detection processor responsive to the at least one distributed network connection;
a memory device responsive to the fault detection processor; and
at least three processing elements responsive to the fault detection processor, whereby the at least one distributed network connection and the at least one network switch are adapted to directly link the distributed processing node to one or more separate distributed processing nodes over a fault tolerant distributed network connection interface.

6. The distributed processing node of claim 5, wherein the at least one distributed network connection is a RapidIO network interface connection.

7. The distributed processing node of claim 5, wherein the at least one distributed network connection is a network interface connection.

8. The distributed processing node of claim 5, wherein each processing element of the at least three processing elements is at least one of a field-programmable gate array, a programmable logic device, a complex programmable logic device, and a field-programmable object array.

9. The distributed processing node of claim 5, wherein the fault tolerant distribution network connection interface is a RapidIO network connection interface.

10. The distributed processing node of claim 5, wherein the fault tolerant distribution network connection interface is a network connection interface.

11. A circuit for maintaining a predetermined level of error handling and recovery in a distributed processing network, comprising:
means for linking one or more interconnections within the distributed processing network;
means, responsive to the means for linking, for simultaneously distributing a plurality of data packets; and
means, responsive to the means for linking and means for distributing, for controlling at least one configuration of one or more processing elements in one or more end nodes.

12. The circuit of claim 11, wherein the means for linking comprises a multi-port network switch.

13. The circuit of claim 11, wherein the means for simultaneously distributing comprises a RapidIO network communications interface.

14. The circuit of claim 11, wherein the means for simultaneously distributing comprises a high speed network communications interface.

15. The circuit of claim 1 1, wherein the means for controlling comprises a reconfigurable processor assembly including external triple modular redundant voting.

16. A method for transferring one or more data packets over a distributed network, comprising the steps of:
establishing one or more interconnections between one or more nodes within the distributed network; and
enabling a simultaneous coupling of one or more communication links between the one or more nodes such that each of the one or more communication links is capable of detecting and recovering from one or more network interface errors without additional intervention.

17. The method of claim 16, wherein the one or more network interface errors comprise at least one of a single event upset, a single event transient, and a single event functional interrupt.

18. The method of claim 16, wherein the step of establishing the plurality of interconnections between the one or more nodes within the distributed network further comprises the step of interconnecting the one or more nodes through a RapidIO network communications interface.

19. The method of claim 16, wherein the step of establishing the plurality of interconnections between the one or more nodes within the distributed network further comprises the step of interconnecting the one or more nodes through a packet-switched network communications interface.

20. The method of claim 16, wherein the step of allowing one or more communication links to occur simultaneously between the one or more nodes further comprises the step of routing multiple data packets between the one or more nodes to process information concurrently.

21. A program product comprising a plurality of program instructions embodied on a processor-readable medium, wherein the program instructions are operable to cause at least one programmable processor included in a distributed processing network to:
participate in establishing a fault tolerant distributed processing application; and
perform, without intervention from a system controller, recovery processing as required to recover from one or more single event faults.

22. The program product of claim 21, wherein the recovery processing further comprises concurrently reconfiguring one or more reconfigurable processor assemblies that sustain at least one substantial single event fault condition.

23. The program product of claim 21, wherein the one or more single event faults comprise at least one of a single event upset, a single event transient, and a single event functional interrupt.
